(19) United States
(12) Patent Application Publication
(10) Pub. No.: US 2014/0115459 A1
(43) Pub. Date: Apr. 24, 2014

(54) HELP SYSTEM

(71) Applicant: Michael Norwood, Sedona, AZ (US)

(72) Inventor: Michael Norwood, Sedona, AZ (US)

(21) Appl. No.: 14/062,858

(22) Filed: Oct. 24, 2013

Related U.S. Application Data
(60) Provisional application No. 61/717,937, filed on Oct. 24, 2012.

(51) Int. Cl. G06F 3/0484

(52) U.S. Cl. CPC G06F 3/0484
USPC 715/708

(57) ABSTRACT

A help function that guides a user through steps presented contextually. Help instructions appear on the GUI within a comment bubble that is pointing to the screen location requiring user input. The bubble also discloses the step the user is executing and the total number of steps involved in the help process. The customized help utility may run as a plug-in on an existing web-based, or a module on non-networked computer system, or be incorporated in with the original software. Users can create a customized Help utility for a particular software, and create messages within a software program.

### CROSS-REFERENCE TO RELATED APPLICATIONS

This is a utility patent application being filed in the United States as a non-provisional application for patent under Title 35 U.S.C. §100 et seq. and 37 C.F.R. §1.53(b) and, claiming the benefit of the prior filing date under Title 35, U.S.C. §119(e) of the U.S. provisional application for patent that was filed on Oct. 24, 2012 and assigned Ser. No. 61/717,937, which application is incorporated herein by reference in its entirety.

### BACKGROUND

This is a utility patent application being filed in the United States as a non-provisional application for patent under Title 35 U.S.C. §100 et seq. and 37 C.F.R. §1.53(b) and, claiming the benefit of the prior filing date under Title 35, U.S.C. §119(e) of the U.S. provisional application for patent that was filed on Oct. 24, 2012 and assigned Ser. No. 61/717,937, which application is incorporated herein by reference in its entirety.

The present disclosure relates specifically to a new system of help for any web or non-web based system and/or software program.

### Discussion of the Related Art

When the first monochromatic monitored personal computer systems rolled out into the market place, such as the APPLE computers or the MICROSOFT 8088 based Personal Computers back in the 1980's, the typical techno-nerd was the typical user. “Help, who needs your stinking help” may have been the attitude of such user. But today, in a world in which every young to middle aged person cringes when receiving a call from an elderly parent with computer questions, there may be a different attitude, a different cry, a different slogan. It may go like this, “HELP!”.

The techno-industry has answered this cry for help. There is the standard cry for help in the form of the “F1” key, the Help menu, the looming “?” link, the online help, the email help, the chat box, the IT guy sitting down the hallway, a group of very silly looking zit-faced high school punks sitting behind a desk at BESTBUY and acting like the actually know something and of course, the GOOGLE search engine. But, in the face of all this so called “help” many a user find themselves in the middle of something and desperately needing help. And typically, the user needs it here and now and does not need for it to distract them from what they are doing. Maybe like little “help fairies” that can pop up on their shoulder and whisper all of the right answers in a very high-pitched squeaky voice. But today, help systems are somewhat intrusive and distracting. There is a need within the computing industry for a solution, such as a computerized system, method and computer program product or plug-in module, etc., to provide “Help” to the user wherein the user is not directed away from the screen where the help instructions are inputted.

In state of the art help systems, end-users are taken to an entirely separate graphical user interface screen (e.g. web page) away from the screen where they need help, and then are either:
Given written directions of a path of user actions to follow to obtain the help they need. They then have to somehow remember that path or print it out, then apply the steps inside the program; or
The user is shown a video of a path of actions to follow to obtain the help they need for a particular feature. Then the user has to somehow remember that path seen on the video and apply it inside the actual program.

Many help systems available today operate to “tell” the user what to do, such as in the form of numbered instructions, or “show” them what to do on video. As such, the user must bounce between the activity for which the user needs help, and the source of the help. This can be time consuming, frustrating, error prone and inefficient. The user tries to memorize all of the steps necessary by interfacing with the help source, then jumping back to the activity of concern and trying to remember and implement the, hopefully memorized steps. However, as one quickly realizes, there are limitations of the human working memory (more commonly called short-term memory). Working memory only can hold 3 or 4 information pieces at a time. This limitation is far exceeded by the amount of information required for learning a new system, software program, application, etc., even if that information is segmented into brief 60 second video tutorials.

While this amount of time is seemingly very brief, it is deceptive how many steps are usually demonstrated in 60 seconds, and thus how much information is required of a new user to remember. Rather than containing the working memory capacity of 3 or 4 steps, 60 second videos often contain as many as 10 to 30 steps (depending upon how fast the demonstrator in the video demonstrates the subject matter).

The end result is users have to watch the video over and over, only able to apply small bits of what they learn at a time. And if there are too many video tutorials of this length (or shorter) required to learn an application, users are discouraged from using the application because of the inconvenience of having to watch so many videos, remembering what was seen, then applying the lessons to the program they are learning.

Likewise, with text-based tutorials, continuously searching on a remote help page for the often dozens of functions needed to start to effectively operate a reasonably in-depth software program is an extremely cumbersome process that is taxing on working memory. It is also very time consuming, especially considering the user may need to go back to the same help functions again and again until they finally learn the program's basic functionality to a point of no longer needing help.

### SUMMARY OF THE DISCLOSURE

The present disclosure focuses on a solution for providing a user help function in a web based program or computer installed program (i.e. non-web based) that is “in context” rather than directing the user to a different screen or window, requiring the user to bounce back and forth or memorize steps.

In various embodiments of the help system presented herein, the user clicks, selects or actuates a help button (collectively and non-limiting is referred to as click) and the help appears right on the same page where the user needs the help.

The user then searches for the help item they need. Once found, the user is taken through the process of actually doing what they need help on via a series of hints that pop up telling the user exactly what to do, 1 step at a time.

Thus, various embodiments of the help system actually instruct and allow the user to “do” what they have to do, each step along the way. Thus, there is no memorization necessary as in the case of video tutorials, or “localization” problems, as is the case with text help systems where the user has to localize on the program what the text is referring to in the help. The various embodiments presented herein thus operate to alleviate or eliminate a substantial amount of the time, stress and frustration users often experience trying to learn all the steps necessary to use a new system, application, software program, etc.

The present disclosure presents one or more embodiments of a help function that overcomes, facilitates or helps to alleviate the drawback of the limitations of human working memory (more commonly called short-term memory).

Various embodiments of the help function disclosed herein, on the other hand, alleviate the need for a user to memorize a list of instructions, enables the user do a single task at a time, and reduces the amount of working memory utilized by a user. This is accomplished in the various embodiments by individual help items being provided through a series of 1-step directions. These directions are on the page pointing to and telling the user exactly what needs to be done for that step. Once the user accomplishes the step, the help function automatically brings the user to the next step of the sequence until the desired function is accomplished.

It should be appreciated that while the various embodiments are described as a “help function”, the embodiments may be hardware, software, firmware, computer systems running a program or executing steps of a program, combinations thereof, etc. Thus, the use of any of these terms, unless specifically noted otherwise, is used interchangeably throughout this description.

The various embodiments of the help function are different than standard prior art “wizards” because these prior art wizards lead a new user through a sequence of steps related to the functioning of the software system as a whole (e.g. “Quick Start wizards). However, the embodiments of the help function take this a step further by granulating this process down to single functions which are accessible and needed for day-to-day operations, both for beginning and advanced levels of usability. Additionally, prior art wizards typically lead the user through a one-time start-up process that is not the same process a user will be using on a day-to-day basis for that application, but rather one designed for start-up purposes. (In other words, many applications make the startup process easier for users than what the process is without the wizard, thus leaving users really not fully knowledgeable how to use the system once the startup/wizard period is over).

Another aspect that may be incorporated into various embodiments of the help function is various hard-coded pre-sets that trigger the help function to initiate a particular wizard sequence. This can be both time-based or usage based.

For example, a particular granulated help sequence can be hard-coded to appear on a page the first 1, 2 or 3 times a user navigates to that page, but not thereafter (unless the user specifically requests it thereafter via the Help link). Or a particular granulated help sequence can be hard-coded to appear on a page the first day, week or month a user is using the software program, but not thereafter (again, unless the user specifically requests it thereafter via the Help link).

Or, another example is the granulated help sequence can be triggered by certain user events. For example, in a task management or list management system, the help sequence to show the user how to limit how many items they are seeing in a list or on a page may be automatically triggered only after, for example, 10 items are listed. (This feature is helpful in a task management or to-do list system where it can be overwhelming for a user to see too many items on a page at once). Thus, the granulated help sequence only appears and does so automatically with no user prompting at a pre-determined time the user would need this form of help.

Help System

The present discloser presents a help function that may be embodied within a computer based system, method and application/software/module, etc. and operates to guide a user through a series of steps elicited from the Help utility linked to the application, program, system, etc., that the user is currently interfacing with or using (collectively and in a non-limiting way, referred to throughout as an “application”). The application may run as a plug-in or add-on on an existing web-based or non-networked computer system. Or the application may be a module incorporated in with the original software. As such, the application is customized to the specific type of environment (e.g. website, system software, etc.) so that the categories, topics, and step-by-step instructions are specific to the environment.

Embodiments of the help function provide a series of instructions comprising a series of user single click actions, wherein the instructions for each step are located next to the input area on the screen for that particular step. In a some embodiments, the instructions may include text based comment bubbles located next to the input area and further comprising arrows pointing from the bubbles to the input area.

In some embodiments, the steps in the help function may comprise: a) activating a general categories help module in response to user performance of a single action on a first graphical user interface screen; b) activating topic specific instructions in response to user performance of a single action on a second graphical user interface screen; c) displaying instructions on subsequent graphical user interface screens comprising description of user input and location of input pertaining to said topic, wherein said instructions are co-located with location of input on said screen; and, d) redirecting system to return to first graphical user interface screen upon completion of said instructions.

Various embodiments of the help function may provide the user a count of the step they are on and the total number of steps in the process.

The help function may further display on the graphical user interface screen visual cues to instruct the user on how to activate the help function and then the steps to follow once it is activated. Visual cues comprise icons, images, symbols, etc. displayed on a screen that point to, or otherwise identify, the button that the user needs to click on in order to activate the help system. The cues (e.g. a number “1” with an arrow pointing to the Help Button) may be designed to only show the first few times the user accesses the help software/module, and/or for the first few days, weeks, months after it is installed.

Hintmaker

Various embodiments of the help function may also incorporate a “hintmaker” function. The hintmaker, may comprise a an application to allow a user, which may be any user but also may be limited to the system administrator and/or his computer programmers) to create a customized Help System for a particular situation. For example, the Help System may be used as a plug-in of a website, added to an existing software product that is downloaded and installed on a user's electronic computing device (e.g. laptop, smartphone, iPad, etc.), and/or accessed via the web by an installed product as needed.

Special features within the hintmaker enable the user to modify the comment bubbles of the Help System for the purpose of customizing it. Features comprise: adding a background image and a transparent image overlay to a comment bubble (e.g. “Hint”); the ability to resize the bubble and move the arrow anywhere along the bubble's border; the ability to select the color of the bubble's border and the background color within the bubble; select the bubble's border thickness, background reflection opacity and thickness; add text boxes within the bubbles, and additional notes on the same page (e.g. to the programmers).

Message Director

The Help System and the Hintmaker may be incorporated in creating messages within a software program, such as messages from an administrator to computer programmers. In a particular exemplification, messages from an administrator of a task management system are relayed to team members or computer programmers of the software. The Message Director enables the administrator to automatically place each of the 3 attachments (hint with auto-filled text, entire image and form) into the Message Screen, which comprises instructions to the computer programmers to modify the software. Additionally, various embodiments may transfer the text inputted into the balloon into a title and/or text and/or description field of a database field, such as in a task management system. In the some embodiments, only the first 60 characters fill the title field, the rest overflowing into the description field. In other embodiments, the text may go directly into only the description field or any other combination of auto-fill that is either hard-coded into the system, or chosen by user preference controls.

### BRIEF DESCRIPTION OF THE DRAWINGS

The above and other features, aspects, and advantages of the present disclosure will become better understood with regard to the following description, appended claims, and accompanying drawings where:

FIG. 1 is a flowchart of steps for a user to follow when utilizing the automated Help System.

FIG. 2 is an illustration of a screen shot of a cue (“1”) to guide the user in activating the Help System.

FIG. 3 is an illustration of a screen shot of the categories a user selects from when identifying their Help topic. Each type of software has a tailored list of categories, topics, and instructions.

FIG. 4 is an illustration of a screen shot listing the topics and the number of total steps involved in executing the task within the topic.

FIG. 5 is an illustration of a screen shot of a text comment bubble with an arrow pointing to a specific location for user 1-click input, and the count of the current step with the count for the total number of steps in performing the task.

FIG. 6 is an illustration of a screen shot of a text comment bubble with an arrow pointing to a specific location for user manual input; wherein upon saving the input the user is automatically redirected to FIG. 2.

FIG. 7A is an illustration of a screen shot of the Hintmaker control panel with no hint and no background image, before anything is started FIG. 7B illustrates the feature of adding: a background image the administrator wishes to position the hint on top of. And FIG. 7C illustrates how the administrator can resize the hint via the lower right corner re-size tab.

FIG. 8 is an illustration of a screen shot demonstrating the software feature of allowing an administrator to change the color of the border for the “Hint” comment bubble.

FIG. 9 is an illustration of a screen shot demonstrating the software feature of allowing the administrator to select the background color of the “Hint” comment bubble.

FIG. 10 is an illustration of a screen shot demonstrating the software feature of allowing an administrator to adjust the comment bubble's border thickness, the reflection thickness, and the reflection opacity.

FIG. 11 is an illustration of a screen shot demonstrating the software feature of allowing an administrator to resize the “Hint” comment bubble, to move the arrow anywhere along the border and adjust its size, and to position the “X” to cancel the bubble anywhere along the bubble border.

FIG. 12 is an illustration of a screen shot of adding one or more text bounding boxes to within a Hint comment bubble.

FIG. 13 is an illustration of a screen shot covering the Note tab and the Save tab.

FIG. 14A is an illustration of the Message Director module operating within an exemplified task manager software DOOLEBRATE. FIG. 14B is an illustration of a screen shot of the left half screen of a task manager software for using the Message Director module.

FIG. 15 is an illustration Message Director input screen overlaying the image of FIG. 14B.

FIG. 16 illustrates a program (e.g. DOOLEBRATE), wherein the information and attachments from the Message Director module have been put into the program (see first task).

FIG. 17 illustrates that when the attachment symbol is clicked on for a particular task, then all of the attachments within that particular task file are disclosed in a drop down menu.

FIG. 18 is a schematic diagram of a client-system server architecture of one embodiment.

FIG. 19 is a schematic diagram of a client (e.g. user's) mobile communications device (e.g. smartphone) comprising modules.

Reference will now be made in detail to the present preferred embodiments, examples of which are illustrated in the accompanying drawings. Wherever possible, the same reference numbers are used in the drawings and the description to refer to the same or the like parts.

### DETAILED DESCRIPTION OF THE VARIOUS EMBODIMENTS

Glossary of Terms

As used herein, the term “Electronic Computing Device” refers to any electronic device comprising a central processing unit (i.e. processor) with the ability to transmit and receive electronic communications from the system server and between parties, and may comprise devices with cellular phone capacity and/or with Voice over Internet Protocol (VoIP) phone capability via a web connectivity, such as: laptops, desktops, Android® tablets, iPads, and smartphones, cell phones, and personal digital assistant devices.

As used herein, the term “Software” refers to computer program instructions adapted for execution by a hardware element, such as a processor, wherein the instruction comprise commands that when executed cause the processor to perform a corresponding set of commands. The software may be written or coded using a programming language, and stored using any type of non-transitory computer-readable media or machine-readable media well known in the art. Examples of software in the present disclosure comprise any software components, programs, applications, computer programs, application programs, system programs, machine programs, and operating system software.

As used herein, the terms “Module” refers to a portion of a computer program or software that carries out a specific function and may be used alone or combined with other modules or algorithms of the same program.

As used herein, the term “A System” may be used to describe all aspects of an embodiment wherein it refers to the entire configuration of hardware and software in all embodiments. In a preferred embodiment, the “system” comprises a user computing device with Internet connectivity (e.g. laptops, tablets, smartphones, etc.). In an alternative embodiment, the system comprises a client-server architecture comprising a user computing device with Internet connectivity, such as laptops, tablets, and smartphones, to communicate with a system server via a network, wherein the software/modules are installed on the system server and electronically communicates with the user's device over the Internet. Furthermore, the user's computing device may have modules installed to assist in creating help instructions and/or hint comment bubbles, or accessible via the web.

As used herein the term “Client” computer or computing device refers to any electronic computing device capable of communicating with a remote server via the Internet such as a smartphone, hand-held “palm top” computer, laptop computer, desktop computer, terminal, PDA (Personal Digital Assistant), PIM (Personal Information Manager), Network computer, wireless communicator (such as a cellular or satellite telephone), or a multi-User computing system.

As used herein the term “Server” computer refers to any computing device that stores and runs a Comment Bubble computer program, houses the system database comprising users' files of stored video that has been commented on, and communicates periodically with the Comment Bubbles module stored on the user's electronic computing device. The server system also facilitates the collection and distribution of content to and from a multiplicity of client computers.

As used herein, the term “Graphical User Interface Screen” refers to electronic computing device's screen where the images are seen.

As used herein, the term “User” refers to the individual who utilizes the Help System to assist them while computing within a webpage and/or non-networked software, mobile application, or any computer code wherein the Help System is installed or available (e.g. plug-in).

As used herein, the term “Administrator” refers to the individual(s) who create a Help System computer code/module/software for a particular application (e.g. a task manager software, a word processing software, a webpage for purchasing products, etc.) The administrator may create the help instructions and/or hint comment bubbles, or direct programmers to do so on an actual live web page or software application or other embodiment. However, it will be appreciated that in some settings an administrator is a special job function but in others, it is simply a user that has access to the administrator functions.

General Process-Help System

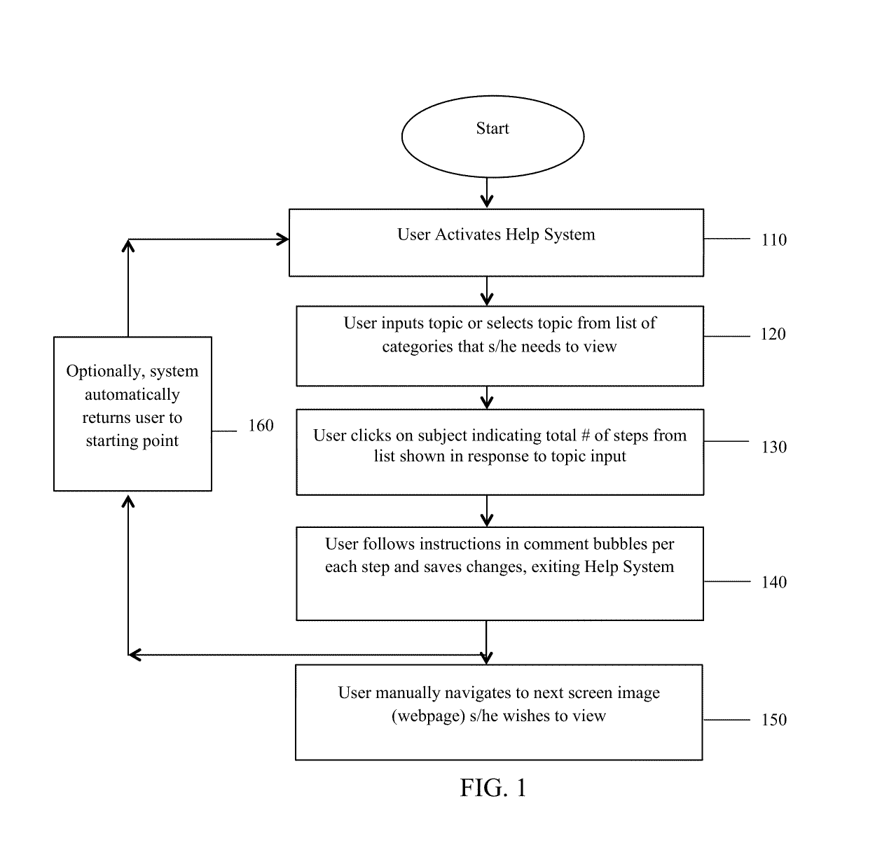

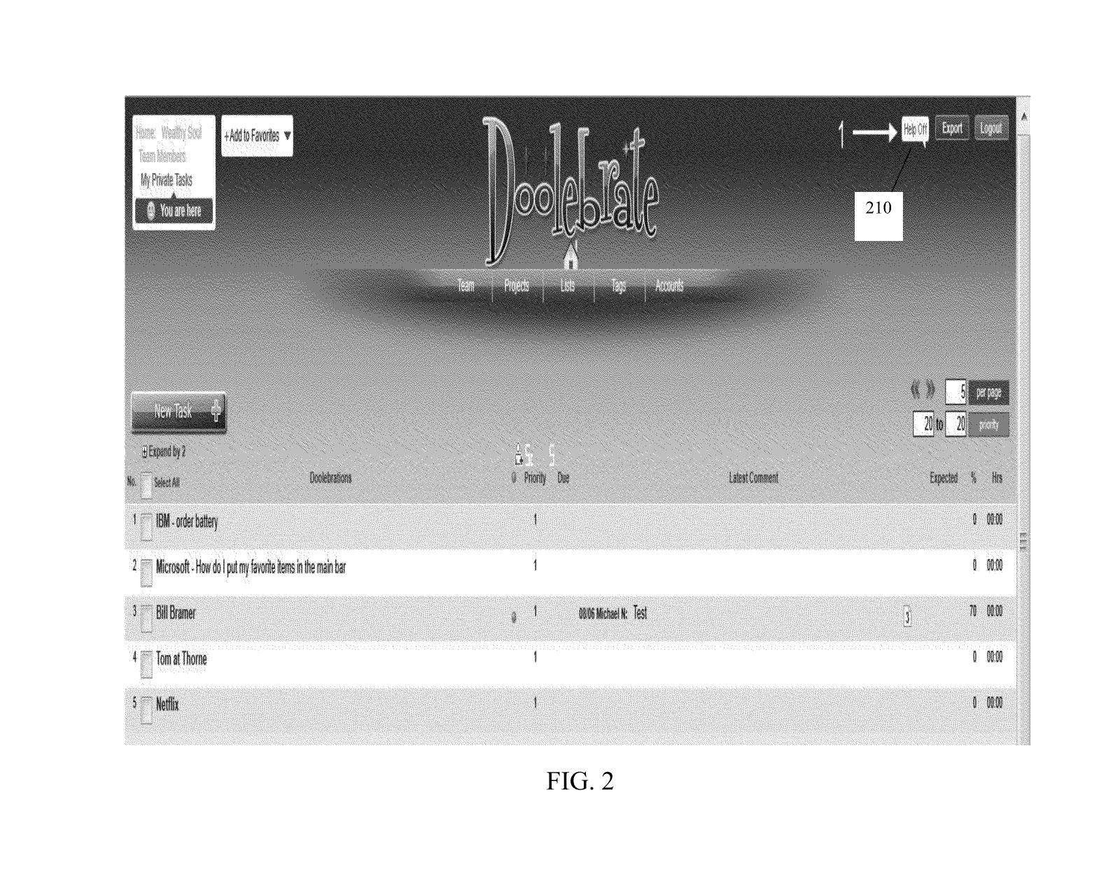

FIG. 1 is a flowchart of steps for executing an exemplary embodiment of the Help System, and FIGS. 2-6 are illustrations of the steps for a particular exemplification within the DOOLEBRATE Task Management Software. The general steps from the user's perspective in utilizing the illustrated embodiment of the Help System are as described below.

In step 110, FIG. 1, the user activates the Help System on whatever webpage or screen s/he is on within a software (e.g. DOOLEBRATE, MICROSOFT, etc.). As exemplified in FIG. 2, 210, the means to activate the Help System may comprise a button that the user clicks on, wherein the help button is at the same location on every page to assist the user in rapidly finding it. Clicking on the button turns the Help System from the “off” setting to the “on setting”. Other means of activating the Help System with one-click by the user would be readily known to one of skill in the art (e.g. computer programmer designing the system).

As further illustrated in FIG. 2, 210, the Help System may prompt the user to activate the Help System by pointing to the button (see FIG. 2, 220, arrow and the number “1” pointing to Help button). The system can be setup so that the step “1” and the arrow appear the first few times the user accesses the program (e.g. the first three times he uses DOOLEBRATE). And/or the system can be setup so that the step “1” and the arrow appear for the first week, month, etc.

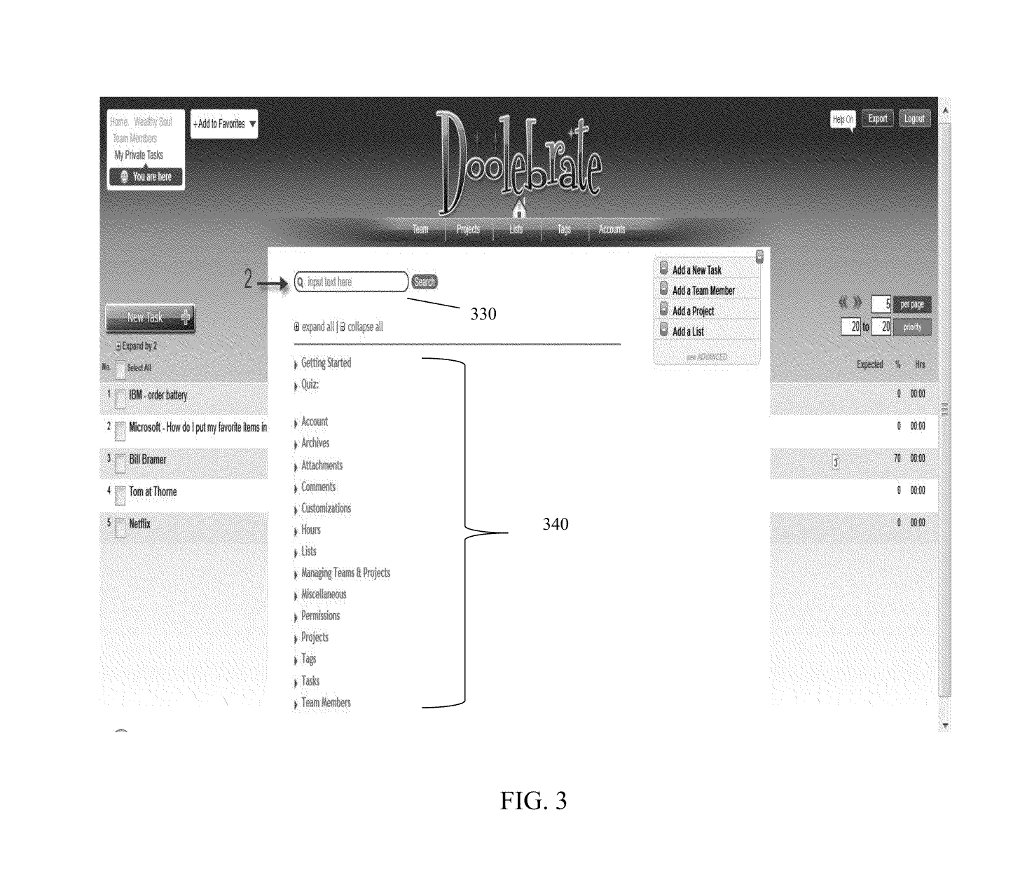

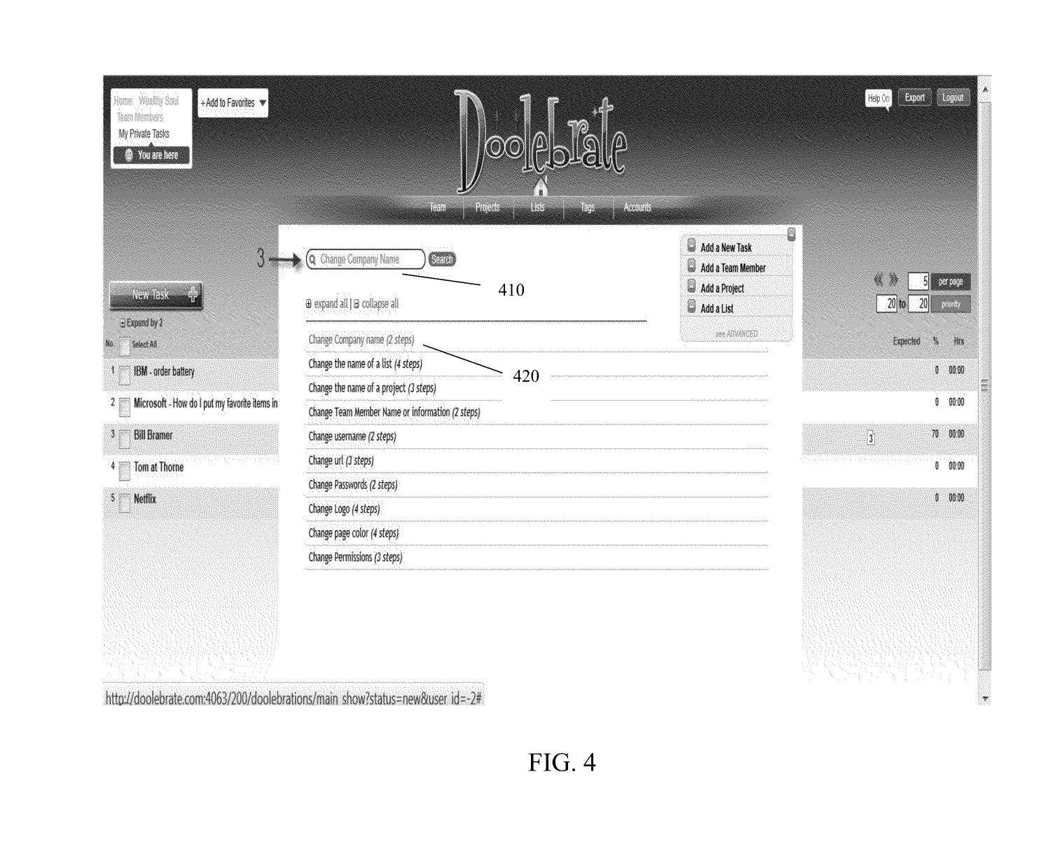

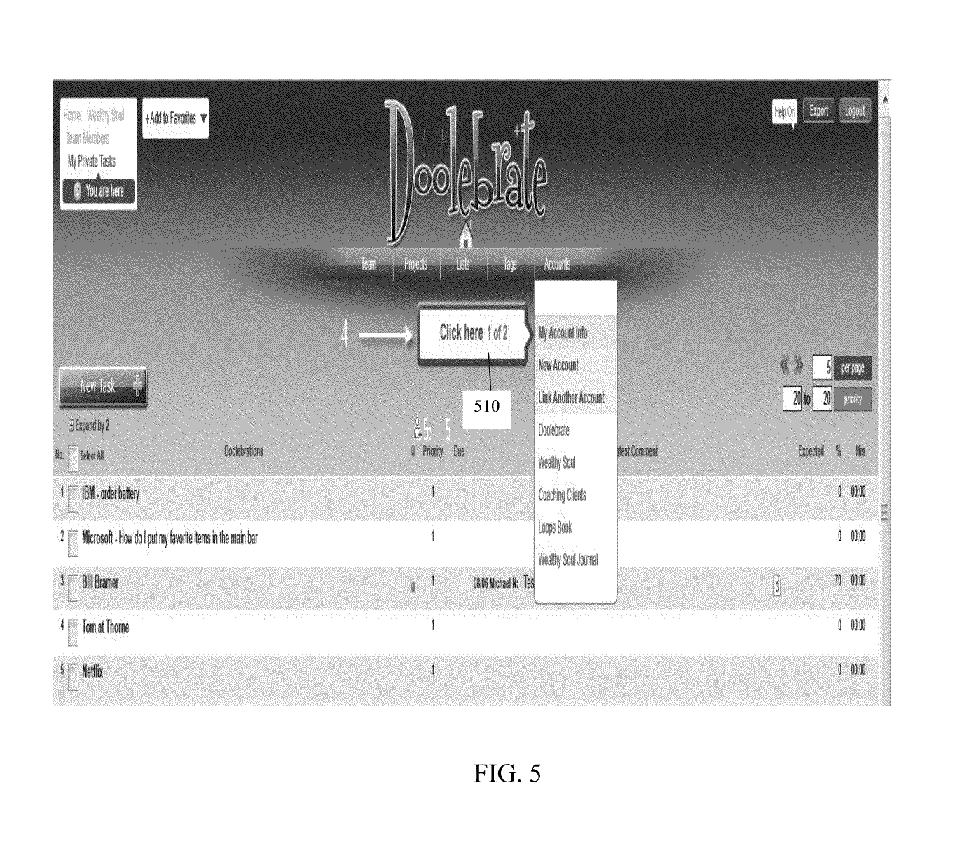

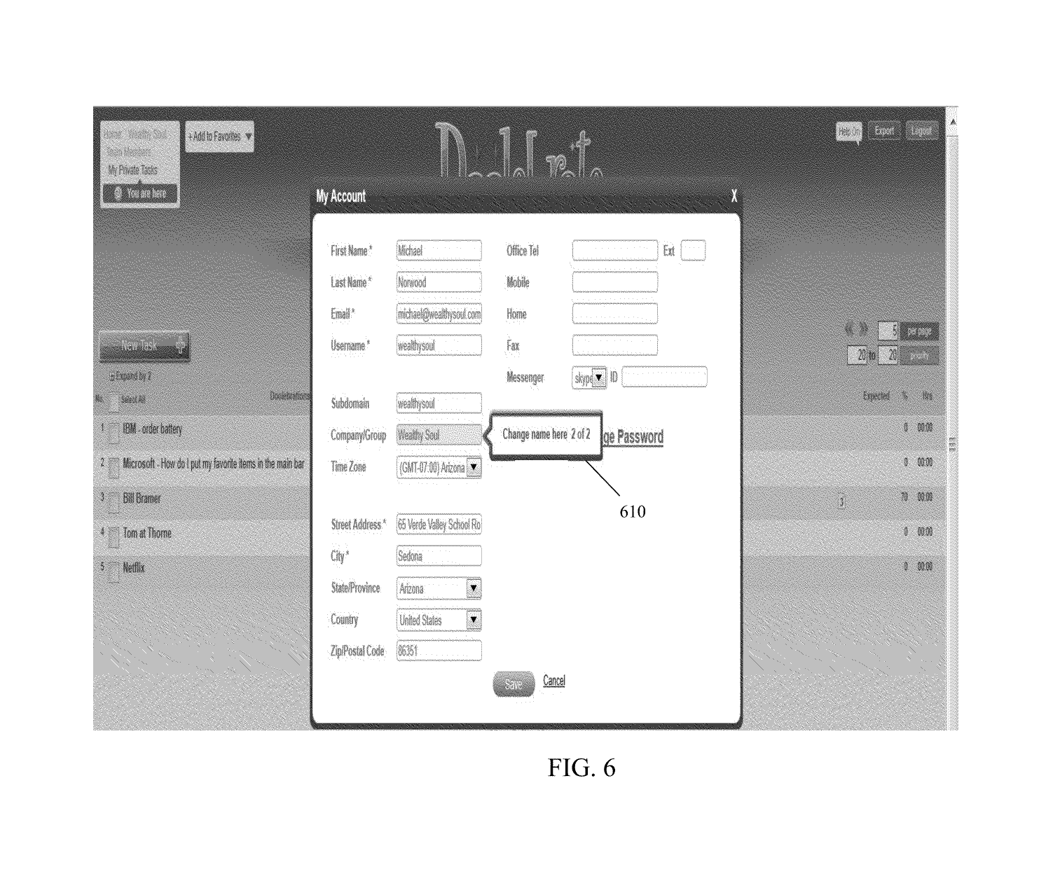

The numbers with arrows may also be color coded to assist the user is quickly locating them on the screen. For example, see the red arrow with “2” on FIG. 3, “3” or FIG. 4, “4” on FIGS. 5, and “5” on FIG. 6.

After activating the Help System, the user searches for a needed help item through a standard help search field (step 120, FIG. 1), (see exemplification FIG. 3, 330); and/or, the user clicks on one of the list of categories that indicates the general area the help subject matter pertains to (see FIG. 3, 340). Each category comprises one or more hide and display help items.

In the exemplification, the user has typed in “change company name” (see FIG. 4, 410), rather than select from the list of categories of FIG. 3, 340. The screen will then display a list of similar topics in addition to the user's input. Next to each topic will be an indication of how many steps are involved in the process (e.g. “2 steps” to change a company name) (see exemplification FIG. 4, 420), (step 130, FIG. 1). When the user clicks on the topic (e.g. “change company name”), then they will be redirected to a screen where the change is made. They will see a text box, such as the red exemplified comment bubble comprising instructions on the actions the user needs to take, and what step this comprises of the total number of steps in the process (see exemplification FIG. 5, 510), (step 140, FIG. 1). When the user takes the action that they are instructed to do (e.g. click on “My Account Info” in FIG. 5), then they will be automatically redirected to the next page to take the next action in the process. For example, in FIG. 6, 610, they are instructed to input the new company name. The comment bubble box also indicates that this is step 2 of 2.

After entering in and saving the new company name the user is automatically redirected back to the page they started from when the activated the Help System (FIG. 2), (step 150, FIG. 1). The user can search for another help item by clicking the help button again, or proceed onto working in the software at the point they left off when they activated the Help System.

Hintmaker

The following disclosure pertains to software/modules for enabling an administrator to easily create the text comment bubbles exemplified in FIGS. 5 and 6 supra.

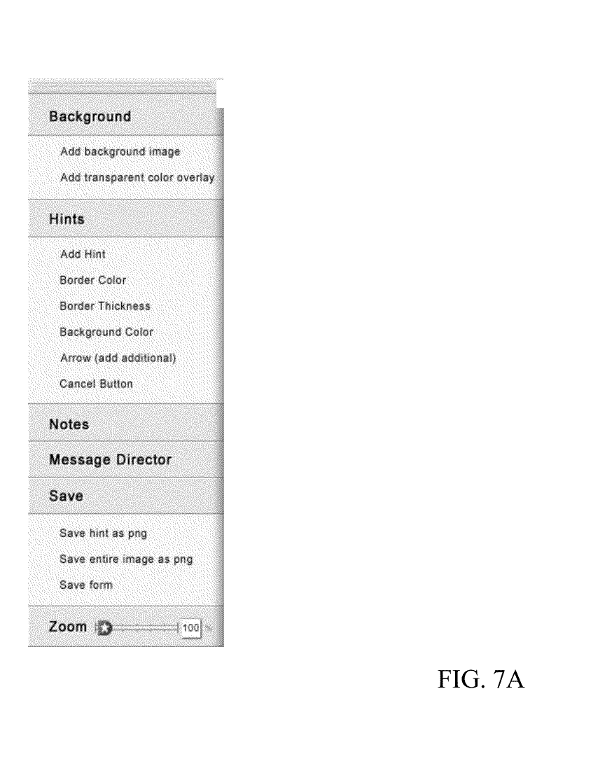

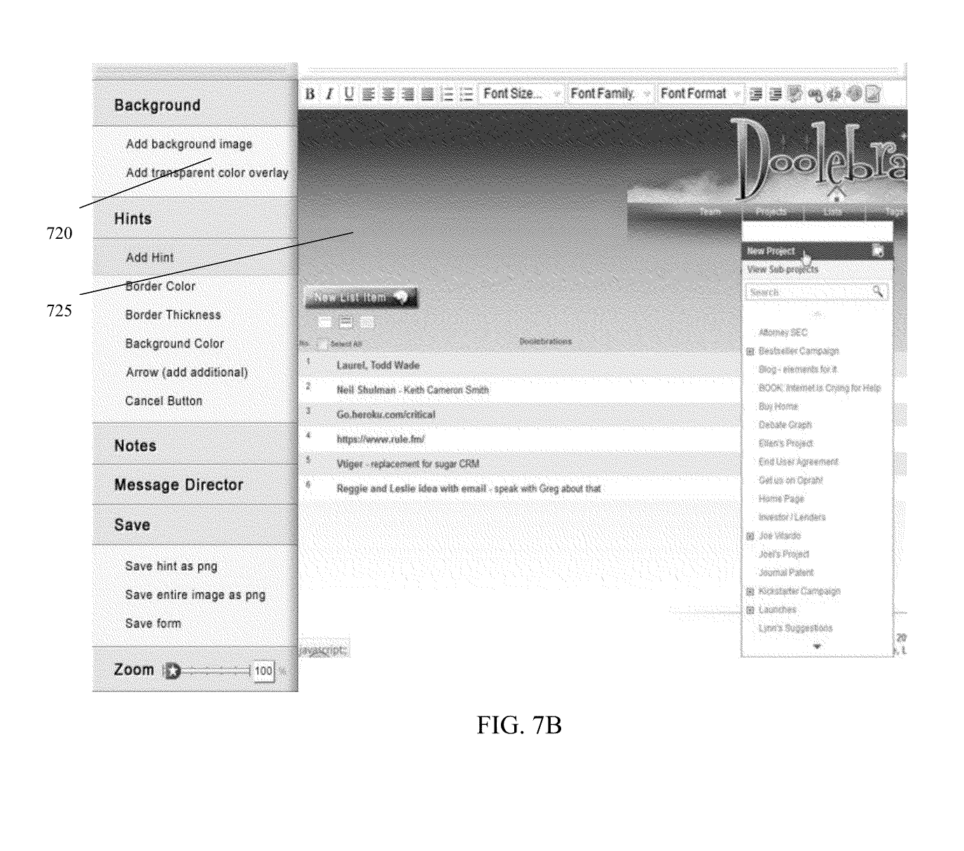

FIG. 7A is the Hintmaker control panel with no hint and no background image, before anything is started. FIG. 7B illustrates the feature of adding: a background image the administrator wishes to position the hint on top of When the administrator selects “Add Background Image” tab 720, a preset image will appear 725, or a drop down will appear comprising a list of background images available, from which the administrator will select one.

FIG. 7C illustrates adding a text comment bubble (i.e. “Hint”) over the image of FIG. 7B. and a transparent image overlay. When the administrator selects “Add Hint” 710 from the left column of task choices, a comment bubble appears 740 on the screen that the administrator may subsequently type text into. And the administrator can elect to add transparent cover overlay 730. Adding a transparent color overlay control allows an administrator to put a gray color or another color overtone over the background image if for some reason they desire this. Additionally, FIG. 7C illustrates how the administrator can resize the hint in the via the lower right corner re-size tab 745. The hint can also be moved in the present embodiment by clicking anywhere on the hint's border, then holding the mouse down and moving the hint anywhere on the background image desired.

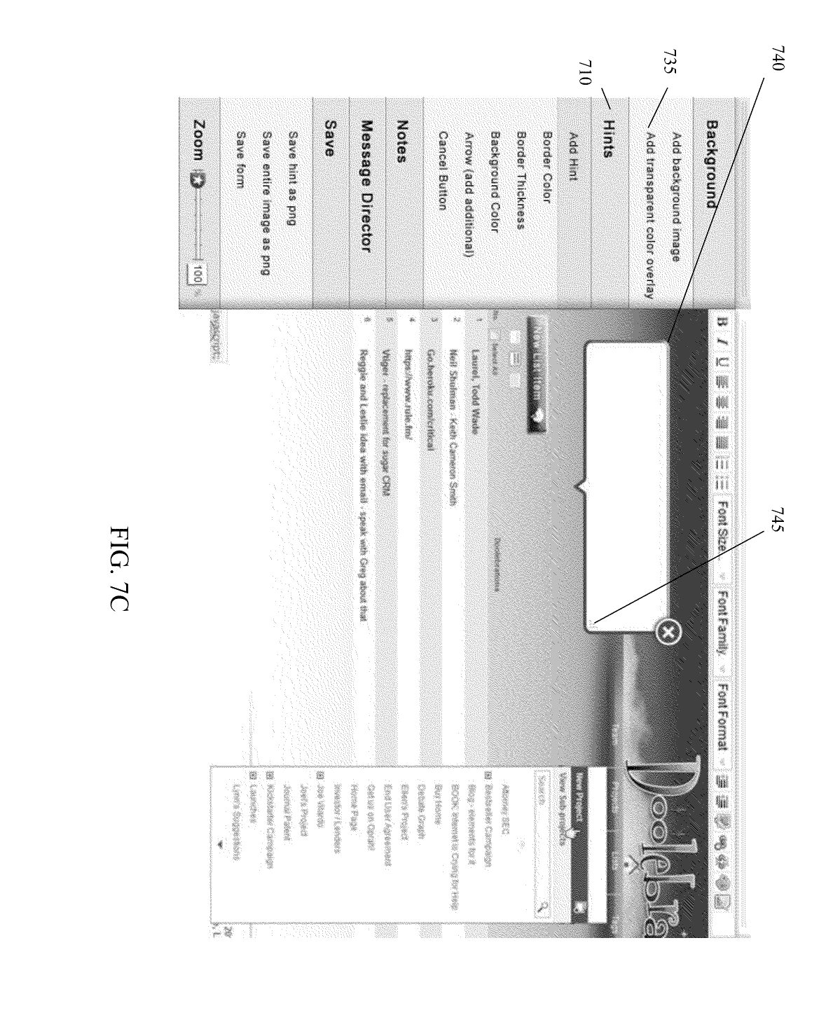

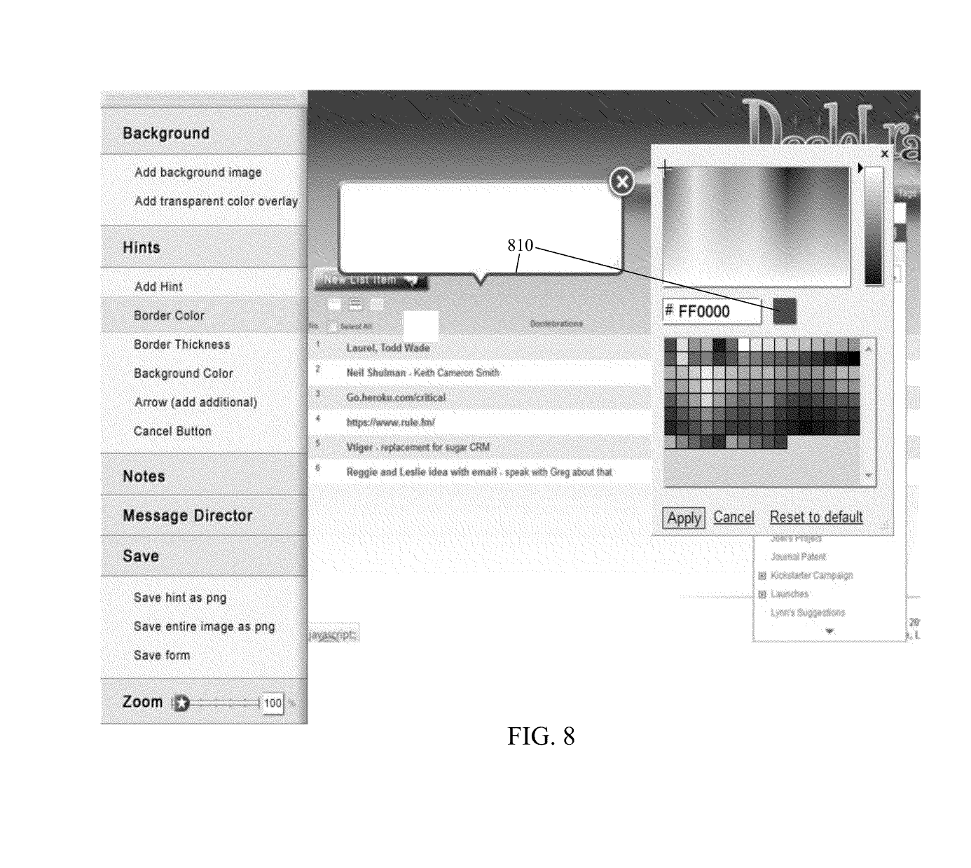

FIG. 8 illustrates the feature of the administrator having the ability to change the color of the border 810 for the “Hint” comment bubble. In this case, the color red is selected 810.

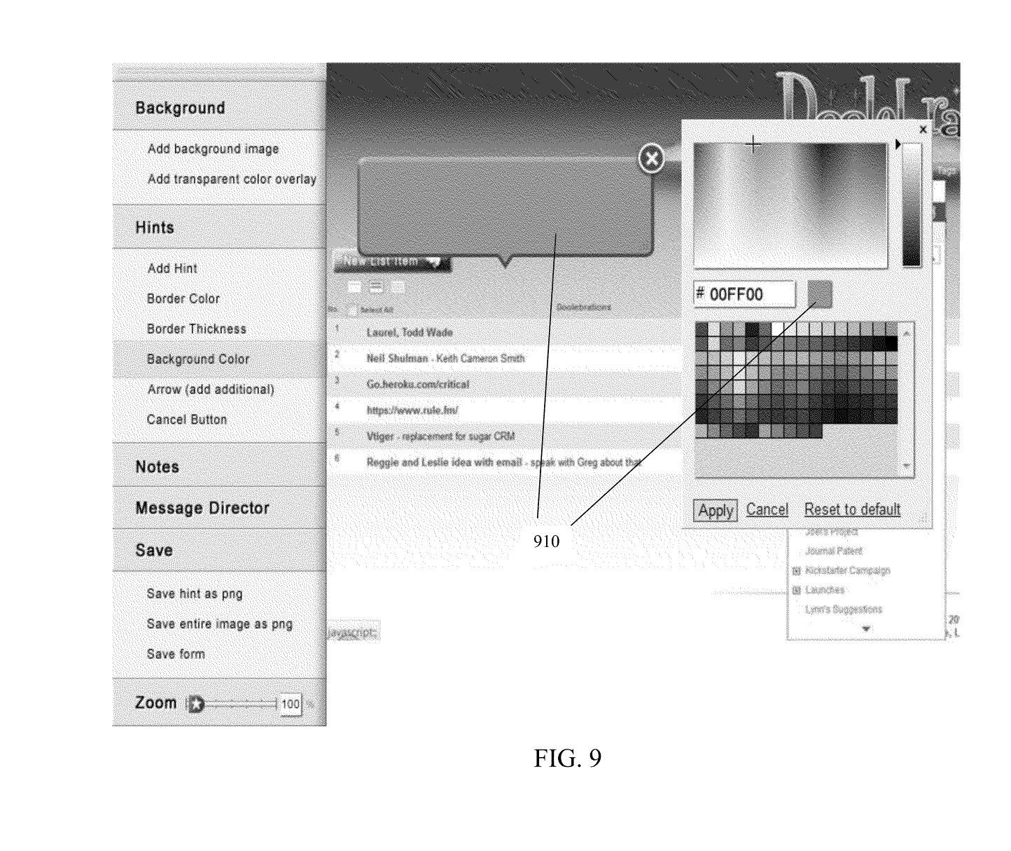

FIG. 9 illustrates the feature of allowing the administrator to change the background color of the “Hint” comment bubble. In this case, the color green is selected from the palette of colors and inserted as the background color 910.

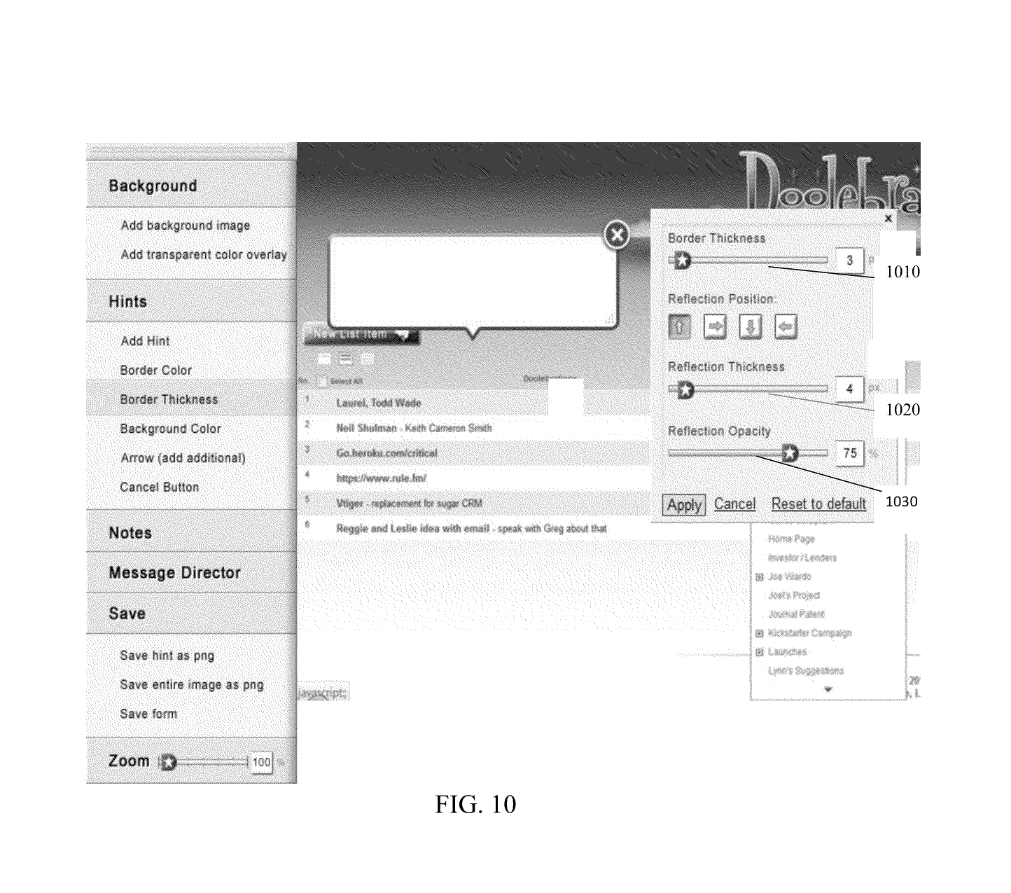

FIG. 10 illustrates the Border Thickness Control feature which allows the administrator to change the thickness of the border 1010, and to put a background reflection around any of the borders to add dimension to it (top, lower, left or right sides). The administrator can adjust the reflection thickness 1020 and the reflection opacity 1030.

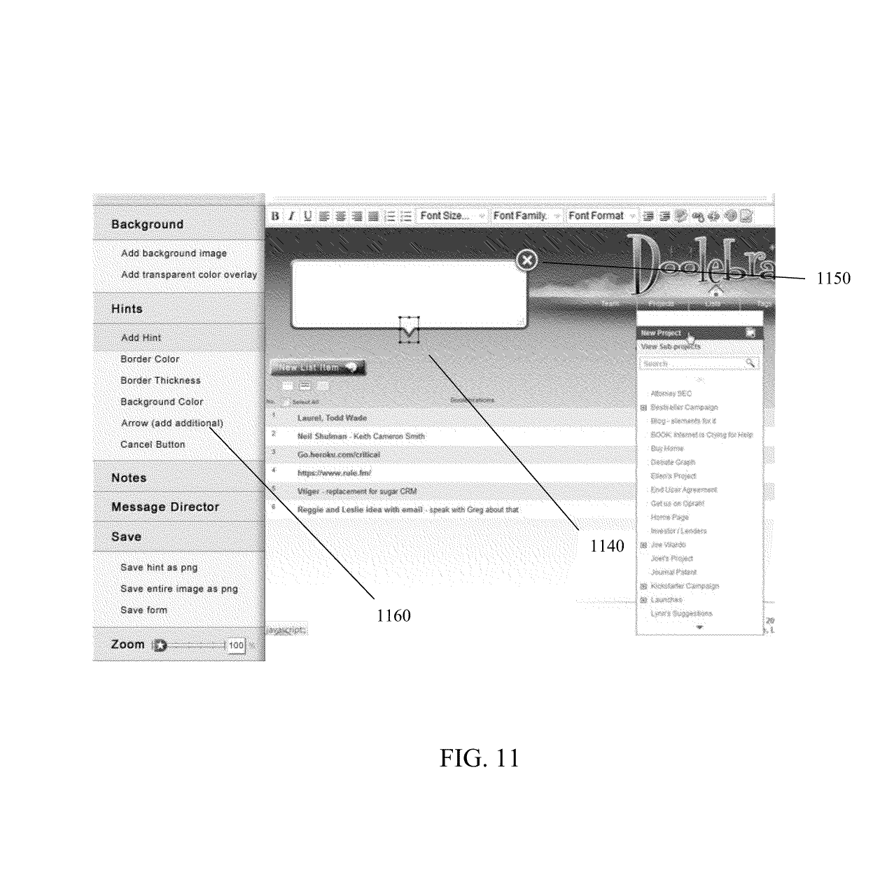

FIG. 11 illustrates the feature of resizing the arrow 1140 of the “Hint” comment bubble, and moving it along the border of the bubble. The arrow can be repositioned anywhere on the exterior of the hint border and resized to any size. The administrator also has the ability to add additional arrows 1140 to the “Hint” comment bubble by clicking on the “Add (additional arrows)” tab 1160 in the left column. The Cancel button 1150 can also be repositioned anywhere along the border of the bubble. Clicking on the button 1150 by the administrator will delete the comment bubble and its contents.

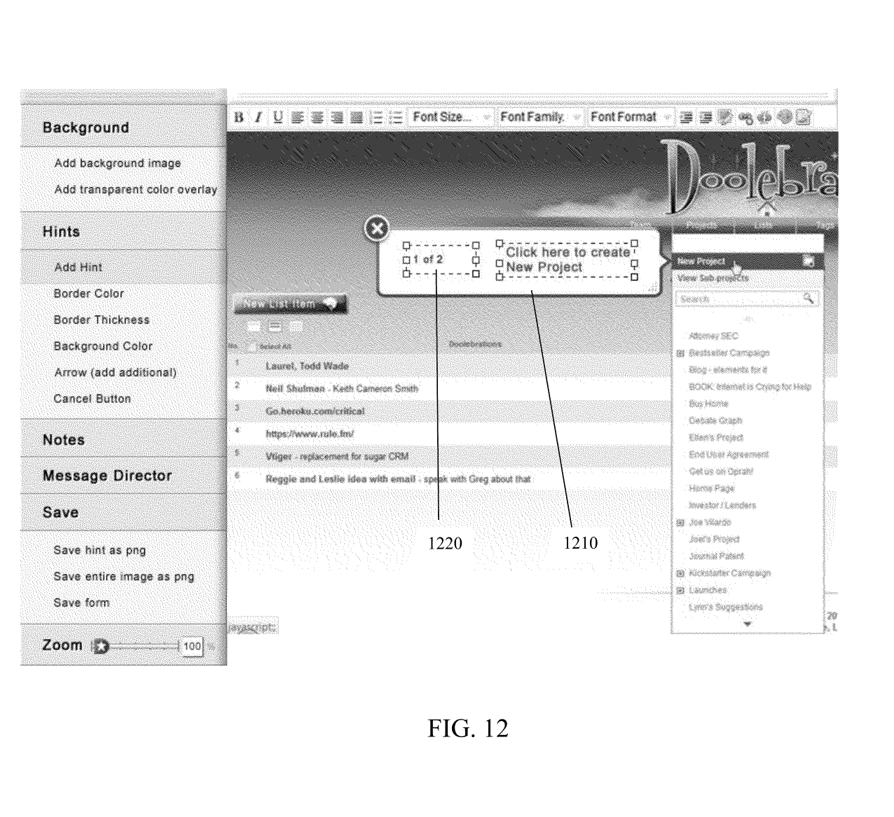

FIG. 12 illustrates that by clicking inside the hint 1210, a text bounding box may appear. In such embodiments, the administrator can put one or more separate sections of text within the hint. An example of a use case for a second bounding box 1220 would be if the user wished to have a second column showing this hint is, for example, hint of “1 of 3”, “2 of 5”, “10 of 10”, etc.

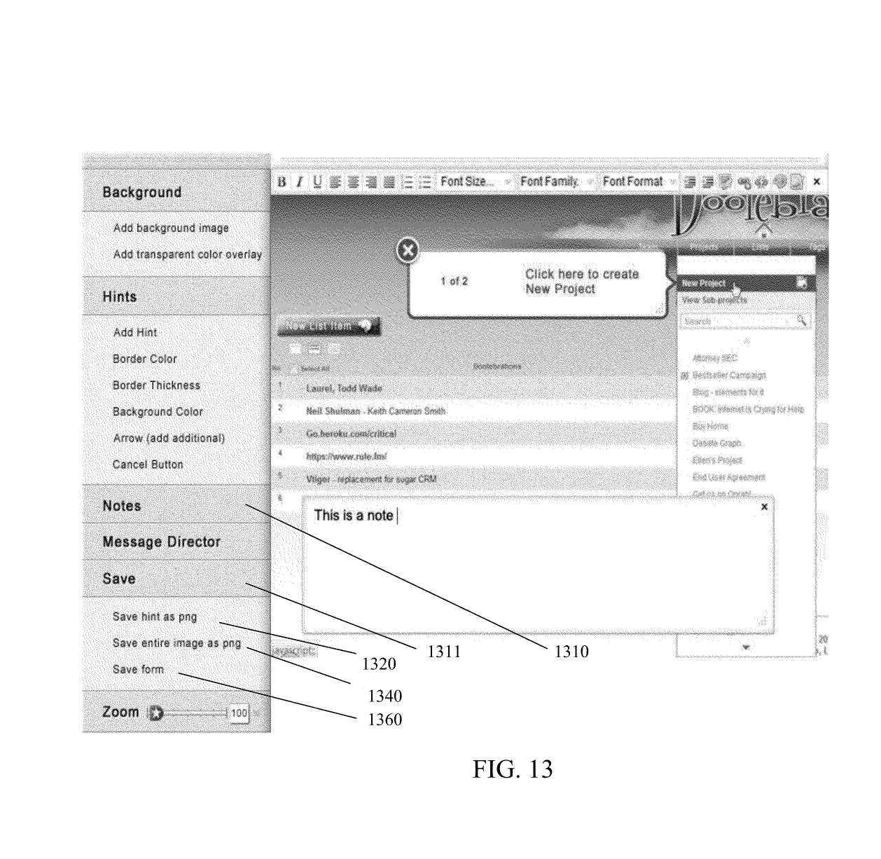

FIG. 13 illustrates the Note tab and the Save tab. The Notes tab 1310 allows the administrator to add notes for themselves or, for example, to the programmers who will actually be placing the hint images in the actual program. The Save tab 1311 provides the administrator three choices. 1) Save the hint comment bubbles as a png file 1320 allows the administrator to save the hint as a separate image file (png, jpg, etc.). 2) Save the Entire Image As Png 1340 allows the administrator to save the hint comment bubble along with the background image and the text notes. This serves as an instructional sheet for the developers to know where exactly to place the hint on the actual live web page or software application or other embodiments. 3) The Save Form tab 1360 allows the image to be saved as a file that can be reopened any time after the system is shut down.

Message Director

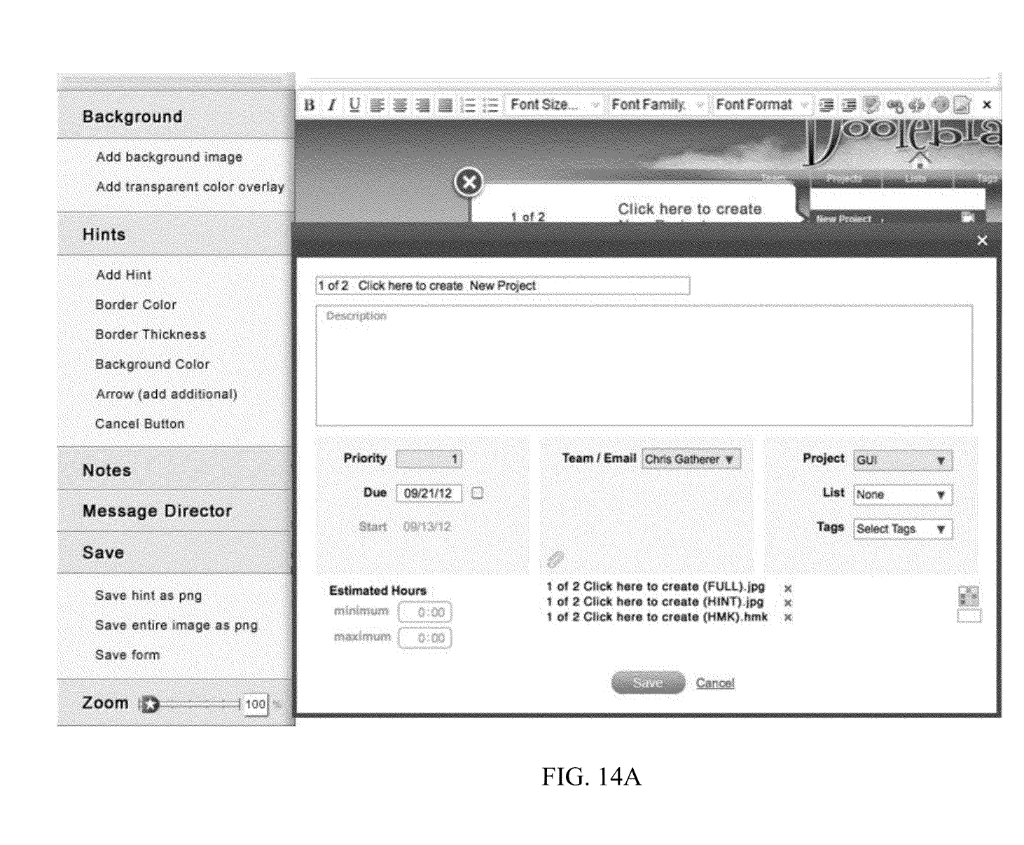

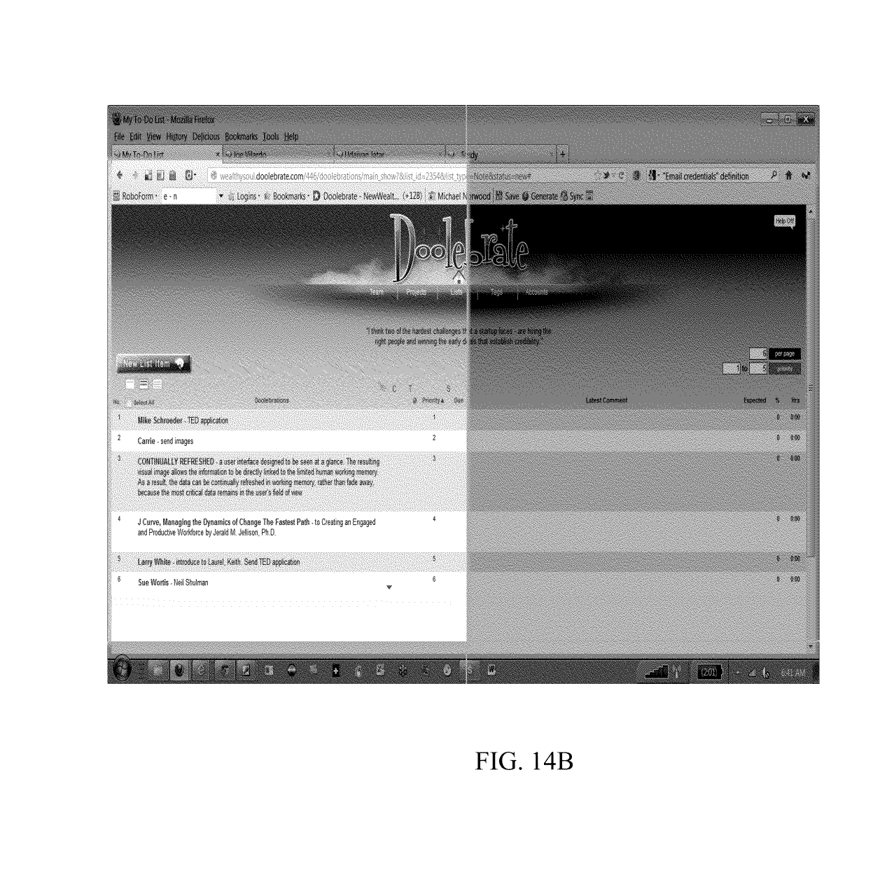

The Message Director tab within the Hintmaker software causes a screen to appear to automatically place each of the 3 attachments (hint, entire image and form) into the Message Director (See FIG. 14A). In the sample embodiment, the text inserted into the hint automatically auto-fills the Message Director. In the present embodiment, only the first 60 characters fill the title field, the rest overflowing into the description field. In other embodiments, the text may go directly into only the description field or any other combination of auto-fill that is either hard-coded into the system, or chosen by user preference controls. Or the user may choose or change the text to whatever Title and/or Description they wish to appear in the list the Message Director will port all its information to.

Step 1

The first step in using the Message Director module comprises importing a screen shot (or relevant parts of the screen image) into the module. The two primary means for the administrator to accomplish this are: 1) by taking a full screenshot or a portion of the screen, as defined by the yellow bounding box in the image (see FIG. 14B). The mechanism of capture can be a Shortcut key (such as Ctrl PrtSc) or any other process common to those knowledgeable in the art, such as pressing a “Print Screen” button, which then would lead to a bounding box appearing on the screen. In the exemplification shown in FIG. 14B, a third party program called “SnagIt” is used to capture the image, which is done by simultaneously invoking the shortcut keys Ctrl & PrtSc then dragging the bars to define the print area. Alternatively, 2) the administrator can import an image or document into the software/module.

Step 2:

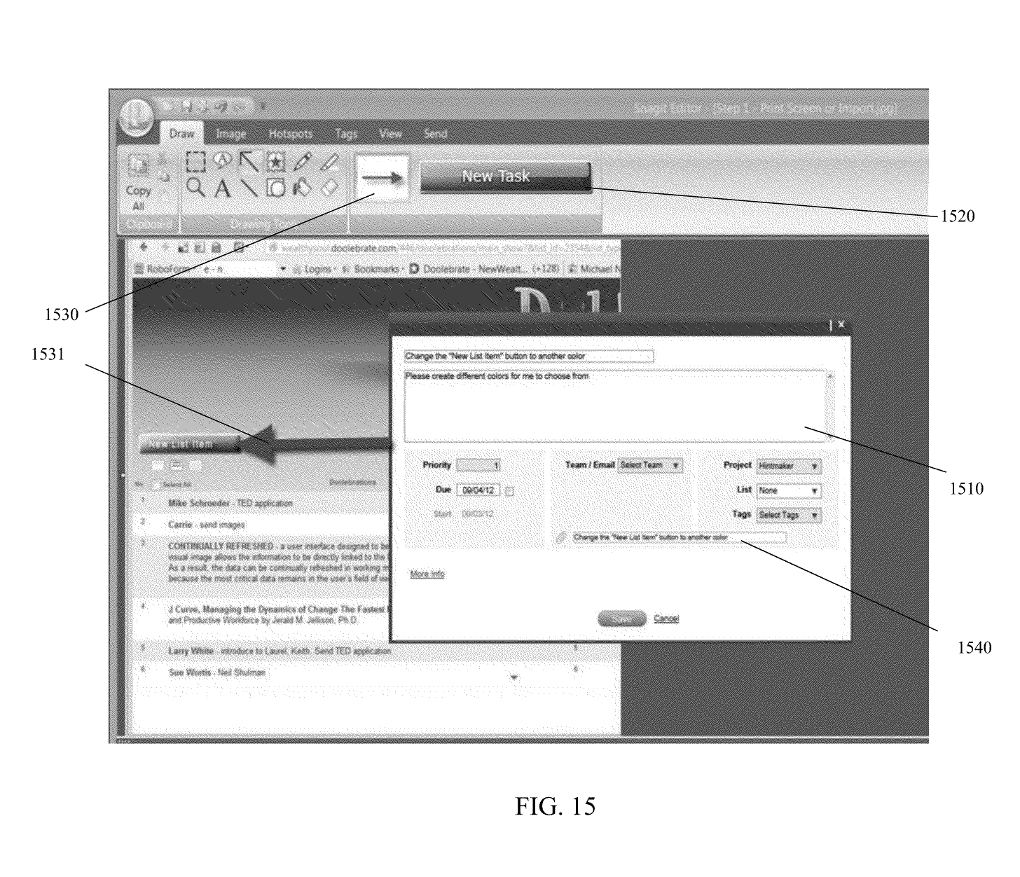

Once the image or screen-shot is imported into the Message Director software/module, the administrator triggers the Message Director™ input screen (see FIG. 15, 1510) by selecting the “New Task” button (see FIG. 15, 1520). Message Director™ input screen 1510 is re-sizeable and moveable to put it on the appropriate place of the image. The administrator can invoke, via an arrow button 1530, the creation of an arrow 1531 to point to different areas of the screen the user wishes to draw attention to that may be related to the information he or she is inputting into the input screen 1510. In lieu of clicking on the arrow button 1530, the administrator can drag an arrow out of the input screen border and extend it to the point of interest (e.g. “New List Item” on FIG. 1510).

As non-limiting example, the information inputted into the screen 1510 may comprise the following items:

Title

Description

Priority Number

Due Date

Start Date

Team Member (to assign it to)

Projects (to assign it to)

Lists (to assign it to)

Tags

Comments

The attachment 1540 (the image of the input screen 1510 on the Screenshot with the arrow) may, in a sample embodiment, automatically be given the name found in the title. The attachment name field is editable so the administrator can change it to any name he or she chooses. When the administrator invokes the “Save” button, the entire attachment 1540 21 is ported into the primary software (e.g. Hintmaker) that the Message Director module is incorporated into or is functioning as a plug-in, add-on, etc. In the exemplification disclosed, the attachment 1540 is imported into the Doolebrate® task management software. (See FIG. 17, 23).

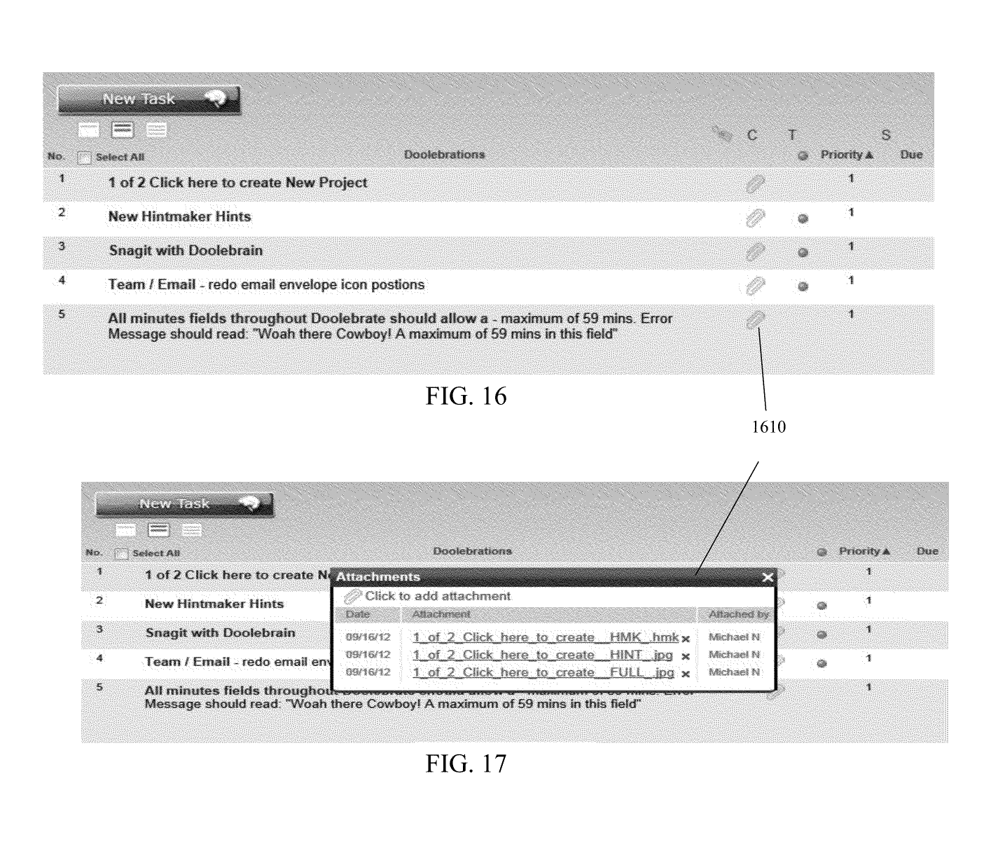

FIG. 16 illustrates a program (e.g. DOOLEBRATE), wherein the information and attachments from the Message Director module have been put into the program (see first task).

FIG. 17 illustrates that when the attachment symbol 1610 of FIG. 16 is clicked on for a particular task, then all of the attachments within that particular task file are disclosed in a drop down menu. Additionally, the text inputted is transferred into the balloon into a title and/or text and/or description field of a database field, such as in a task management system. In the present embodiment, only the first 60 characters fill the title field, the rest overflowing into the description field. In other embodiments, the text may go directly into only the description field or any other combination of auto-fill that is either hard-coded into the system, or chosen by user preference controls.

General System Architecture

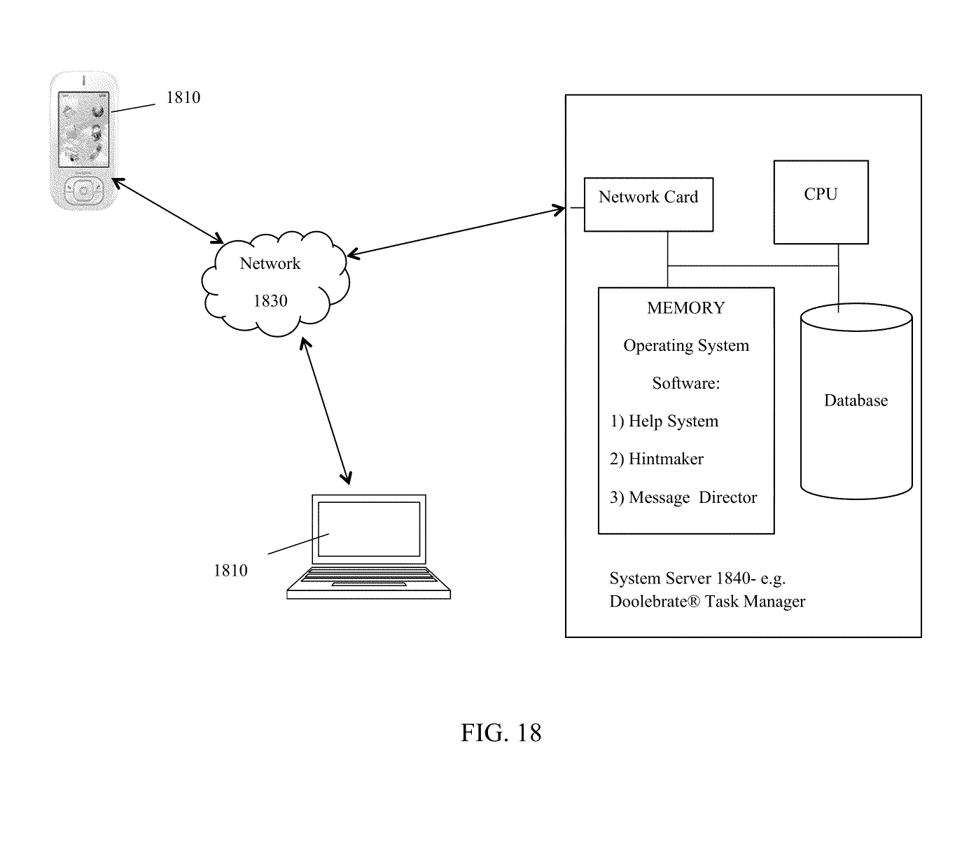

As illustrated in FIG. 18, the general system architecture of various embodiments may include the following elements: 1) a Client1 System 1810 of a user1 (e.g. laptop); 2) the Client2 System 1820 of another user2 (e.g. laptop); 3) the Network 1830; and 4) the System Server 1840 to communicate with the clients' systems.

The “Network” comprises any public network such as the Internet or World Wide Web, or any public or private network as may be developed in the future, which provides a similar service as the present Internet. A Client System 1810 is a User's electronic communications device with web browser capabilities (e.g., laptop, smartphone, etc. . . . ) configured to communicate with the System Server 1840 via the Network 1830, in order to receive and respond to system reports regarding the subject's electronic communications activities. Likewise, the Subject System 1830 is a Subject's electronic communications device with web browser capabilities (e.g., laptop, smartphone, etc. . . . ) configured to be monitored by the System Server 1840 via the Network 1830. The User's and Subject's System may connect to the network via a variety of methods such as a phone modem, wireless (cellular, satellite, microwave, infrared, radio, etc.) network, Local Area Network (LAN), Wide Area Network (WAN), or any such means as necessary to communicate to a server computer connected directly or indirectly to the Network. In one embodiment, the Client System 1820 and 1830 are personal computers running software comprising Help System, Hintmaker, and Message Director modules for use with one or more software programs on the client systems.

The Service Provider System 1840 comprises: a network card or other device for connecting to the Network 1830; a Memory unit comprising random access memory (RAM) for program execution, flash memory, and hard disc drive and storing the subject matter detection and reporting software; a central processing unit (CPU) executing the Help System algorithm/software; and a system database storing records of the User's Account and Activity. Records may comprise, for example: user's task management software accounts with customized Help System, Hintmaker, and Message Director modules.

Mobile Device Schematic

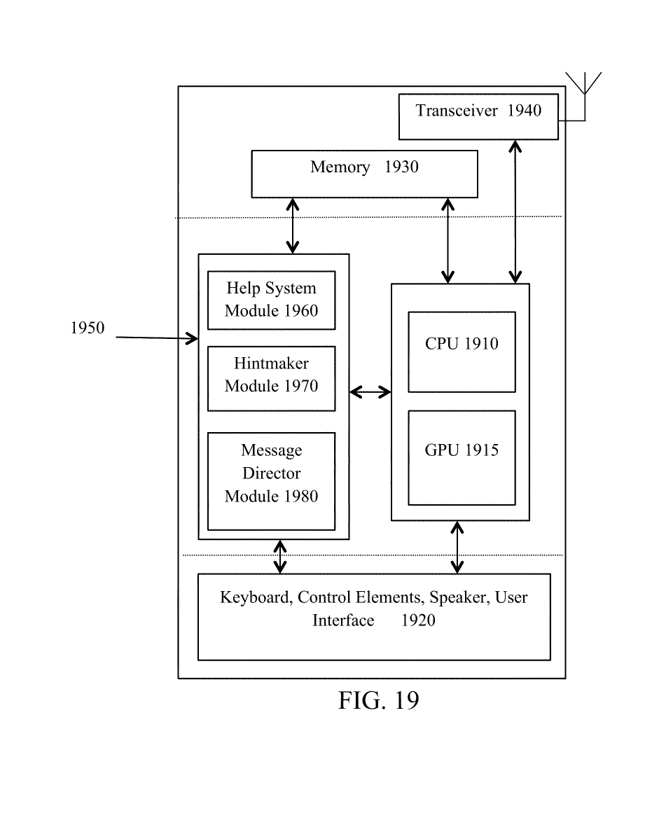

FIG. 19 is a schematic diagram of an exemplified smartphone with Help System, Hintmaker, and Message Director modules and/or software installed for use in the various embodiments. As illustrated in FIG. 19, the system architecture for some embodiments comprises the modules computer program product installed on the electronic computing device, comprises: a central processing unit (CPU) 1910; a User interface with touchscreen data input keypad 1920; memory 1930 such as random access memory (RAM), read only memory (ROM), nonvolatile memory such as EPROM or EEROM, flash memory or hard drive memory; a transceiver 1940 functionally connected to an antenna to receive and transmit data in a wireless network. The transceiver may operate according to standards commonly known in the art by the skilled practitioner, such as for GSM, GPRS, wireless local and personal area network standards, and Bluetooth. The device may further comprise a GPU 1915 comprises a graphics rendering module configured to perform various tasks related to calculating and displaying the comments at a set frame rate. It will be appreciated by one skilled in the art that the system described above is illustrative and that variations modifications are possible as applicable to other user's client computing devices (e.g. laptops).

The device further comprises modules and/or software for use in inserting comments into videos stored and retrieved on the user's device, and/or stored and retrieved from a networked location, such as their file on the system database. The modules 1950 comprise the Help System module 1960, as well as Hintmaker modules 1970, and Message Director modules 1980.

The client computer has a secondary memory device, such as, for example, a hard disk drive or other non-volatile memory. The client program of the system is stored on the secondary memory device of the client computer, such as a mobile device (e.g. smartphone) and is executed by the client computer's processor. It will be appreciated by one with skill in the art that the module might be installed on the client computer as a mobile application from a number of sources such as, for example, downloaded over the Internet from a server, or bundled with software provided by another software manufacturer (such as a Web browser provided by a Web browser manufacturer). It will be appreciated that the application will function in substantially the same manner regardless of the installation source or method.

Electronic schematic configurations of laptop and desktop computing devices are well known in the art. For example, US 20120215328, discloses the schematics of a laptop computer (see FIG. 5).

Computer Program Product

The client device (user's or administrator's computing device) (e.g. smartphone, laptop, etc.) may comprise a native application, a web application, or a widget type application to carry out the methods of the Help System, Hintmaker, and Message Director modules. In a preferred embodiment, a native application is installed on the device, wherein it is either pre-installed on the device or it is downloaded from the Internet. It may be written in a language to run on a variety of different types of devices; or it may be written in a device-specific computer programming language for a specific type of device. In another embodiment, a web application resides on the system server and is accessed via the network. It performs basically all the same task as a native application, usually by downloading part of the application to the device for local processing each time it is used. The web application software is written as Web pages in HTML and CSS or other language serving the same purpose, with the interactive parts in Javascript or other language serving the same purpose. Or the application can comprise a widget as a packaged/downloadable/installable web application; making it more like a traditional application than a web application; but like a web application uses HTML/CSS/JavaScript and access to the Internet.

Although the various features, aspects and functions of the invention have been described with reference to specific embodiments thereof, this description is not meant to be construed in a limiting sense. Various modifications of the disclosed embodiments, as well as alternate embodiments, will become apparent to persons skilled in the art upon reference to the description of the invention. It is therefore contemplated that such modifications can be made without departing from the spirit or scope of the present invention as defined.

What is claimed is:

1. A method for causing a computer system to display instructions to a user to accomplish a task, the method comprising:
a) activating a help module, tailored to a specific computer program, on a computer system, in response to a user performing a single action on a first user interface;
b) selecting a general category in response to the single action on a second user interface screen;
c) selecting topic specific instructions in response to the single action on a third graphical user interface screen;
d) displaying instructions on subsequent user interface screens comprising description of user input and location of input pertaining to said topic, wherein said instructions are co-located with location of input on said screen; and,
e) returning to said first graphical user interface screen upon completion of said instructions.

2. The method of claim 1, wherein selecting topic specific instructions comprises a user selecting said topic from list of categories displayed in response to the single action.

3. The method of claim 1, wherein selecting topic specific instructions comprises a user selecting manually inputting the topic.

4. The method of claim 1, wherein displaying instructions further comprises displaying the count of the current step in user actions and the count of the total number of steps for user action as pertains to said topic.

5. The method of claim 1, wherein said displaying instructions comprises displaying comment text bubbles describing user necessitated action;

6. The method of claim 5, wherein said bubble is aligned with said input location and further comprises a directional arrow pointing from said bubble to said input location.

7. The method of claim 1, wherein activating said help module further comprises displaying user cues on the first graphical user interface screen indicating the means to activate said module.

8. The method of claim 7, wherein said cues are displayed after a designated number of times after the module is first accessed by the user, a designated calendar duration after the module is installed, a designate number of a type of user actions, or a designated sequence of user actions.

9. A computer implemented method for causing a computer system to automatically provide help instructions to a user through a series of inputs to accomplish a task, comprising processor(s) on a system server:
a) activating a help module tailored to a specific computer program, in response to user performance of a single action on a first graphical user interface;
b) selecting a general category in response to user performance of a single action on a second graphical user interface screen;
c) selecting topic specific instructions in response to user performance of a single action on a third graphical user interface screen;
d) displaying instructions on subsequent graphical user interface screens comprising description of user input and location of input pertaining to said topic, wherein said instructions are co-located with location of input on said screen; and,
e) redirecting system to return to said first graphical user interface screen upon completion of said instructions.

10. The method of claim 9, wherein selecting topic specific instructions comprises a user selecting said topic from a list of categories in response to performance of a single action.

11. The method of claim 10, wherein if said topic is not shown in said list of categories, then user manually inputs topic.

12. The method of claim 9, wherein displaying instructions further comprises displaying the count of the current step in user actions and the count of the total number of steps for user action as pertains to said topic.

13. The method of claim 9, wherein said displaying instructions comprises displaying comment text bubbles describing user necessitated action;

14. The method of claim 13, wherein said bubble is aligned with said input location and further comprises a directional arrow pointing from said bubble to said input location.

15. The method of claim 9, wherein activating said help module further comprises displaying user cues on the first graphical user interface screen indicating the means to activate said module.

16. The method of claim 15, wherein said cues are displayed a designated number of times after the module is first accessed by the user, or a designated calendar duration after the module is installed.

17. A computer system for causing a computer system to automatedly provide prompts to direct a user through a series of inputs to accomplish a task, comprising:
a) a system server, comprising;
i) a database that stores records for user's saved help modules created for specific applications/software;
ii) a non-transitory computer-readable storage device comprising instructions for processor(s), wherein said processors are configured to execute said instructions to perform operations comprising;
activating a help module tailored to a specific computer program, in response to user performance of a single action on a first graphical user interface;
selecting a general category in response to user performance of a single action on a second graphical user interface screen;
selecting topic specific instructions in response to user performance of a single action on a third graphical user interface screen;
displaying instructions on subsequent graphical user interface screens comprising description of user input and location of input pertaining to said topic, wherein said instructions are co-located with location of input on said screen; and,
redirecting system to return to said first graphical user interface screen upon completion of said instructions.
b) one or more client computers comprising a graphical user interface for communicating with said system server; and,
c) a network for transmitting electronic communications between said client systems and said server system.

18. The system of claim 17, wherein displaying instructions further comprises displaying the count of the current step in user actions and the count of the total number of steps for user action as pertains to said topic.

19. The system of claim 17, wherein said displaying instructions comprises displaying comment text bubbles describing user necessitated action;

20. The system of claim 19, wherein said bubble is aligned with said input location and further comprises a directional arrow pointing from said bubble to said input location.
